(19) United States
(12) Patent Application Publication
(10) Pub. No.: US 2020/0084395 A1
(43) Pub. Date: Mar. 12, 2020

(54) PERIPHERY MONITORING DEVICE

(71) Applicant: AISIN SEIKI KABUSHIKI KAISHA, Kariya-shi (JP)

(72) Inventors: Kazuya WATANABE, Anjo-shi (JP); Kinji YAMAMOTO, Anjo-shi (JP)

(73) Assignee: AISIN SEIKI KABUSHIKI KAISHA, Kariya-shi (JP)

(21) Appl. No.: 16/561,216

(22) Filed: Sep. 5, 2019

(30) Foreign Application Priority Data
Sep. 6, 2018 (JP) 2018-167140

(51) Int. Cl. H04N 5/272; B60R 1/00

(52) U.S. Cl. CPC H04N 5/272; B60R 1/00; B60R 2300/607; B60R 2300/105; B60R 2300/307; B60R 2300/303

(57) ABSTRACT

A periphery monitoring device includes: an acquisition unit configured to acquire a current steering angle of a vehicle; an image acquisition unit configured to acquire a captured image from an imaging unit that images a periphery of the vehicle; and a control unit configured to cause a display unit to display a composite image including a vehicle image illustrating the vehicle, and a peripheral image illustrating the periphery of the vehicle based on the captured image, and cause the display unit to display a virtual vehicle image illustrating a shape of the vehicle superimposed at a position where the vehicle exists when travels by a predetermined distance at the current steering angle based on a position of the vehicle illustrated by the vehicle image in the composite image when a detection unit capable of detecting an object coming in contact with the vehicle is in an operating state.

### CROSS REFERENCE TO RELATED APPLICATIONS

This application is based on and claims priority under 35 U.S.C. § 119 to Japanese Patent Application 2018-167140, filed on Sep. 6, 2018, the entire contents of which are incorporated herein by reference.

### TECHNICAL FIELD

This disclosure relates to a periphery monitoring device.

### BACKGROUND DISCUSSION

A technology has been developed in which a composite image including a vehicle image of a vehicle and a peripheral image of the periphery thereof is generated based on a captured image obtained by imaging the periphery of the vehicle by an imaging unit, and a display screen including the generated composite image is displayed on a display unit so as to provide a driver with a situation around the vehicle.

Meanwhile, although the vehicle includes a detection unit that detects an object that may come in contact with the vehicle, it is required that whether the detection unit is placed in an operating state be easily recognizable from the display screen displayed on the display unit.

Thus, a need exists for a periphery monitoring device which is not susceptible to the drawback mentioned above.

### SUMMARY

A periphery monitoring device according to an aspect of this disclosure includes, as an example, an acquisition unit configured to acquire a current steering angle of a vehicle; an image acquisition unit configured to acquire a captured image from an imaging unit that images a periphery of the vehicle; and a control unit configured to cause a display unit to display a composite image including a vehicle image illustrating the vehicle, and a peripheral image illustrating the periphery of the vehicle based on the captured image, and cause the display unit to display a virtual vehicle image illustrating a shape of the vehicle superimposed at a position where the vehicle exists when travels by a predetermined distance at the current steering angle acquired by the acquisition unit based on a position of the vehicle illustrated by the vehicle image in the composite image when a detection unit capable of detecting an object coming in contact with the vehicle is in an operating state.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a state where a part of a vehicle cabin of a vehicle equipped with a periphery monitoring device according to a first embodiment is seen through;

FIG. 2 is a plan view of an example of the vehicle according to the first embodiment;

FIG. 3 is a block diagram illustrating an example of a functional configuration of the vehicle according to the first embodiment;

FIG. 4 is a block diagram illustrating an example of a functional configuration of an ECU included in the vehicle according to the first embodiment;

FIG. 5 is a view illustrating a display example of a display screen by the ECU included in the vehicle according to the first embodiment;

FIG. 6 is a view illustrating a display example of the display screen by the ECU included in the vehicle according to the first embodiment;

FIG. 7 is a view for explaining an example of a method of displaying a virtual vehicle image by the ECU included in the vehicle according to the first embodiment;

FIG. 8 is a view for explaining an example of the method of displaying the virtual vehicle image by the ECU included in the vehicle according to the first embodiment;

FIG. 9 is a view for explaining an example of a method of determining a color of polygons constituting the virtual vehicle image by the ECU included in the vehicle according to the first embodiment;

FIG. 10 is a view illustrating an example of the display screen by the ECU included in the vehicle according to the first embodiment;

FIG. 11 is a view for explaining an example of a processing of highlighting a partial image by the ECU included in the vehicle according to the first embodiment;

FIG. 12 is a view for explaining an example of the processing of highlighting the partial image by the ECU included in the vehicle according to the first embodiment;

FIG. 13 is a view illustrating an example of a display screen by an ECU included in a vehicle according to a second embodiment;

FIG. 14 is a view illustrating an example of the display screen by the ECU included in the vehicle according to the second embodiment;

FIG. 15 is a view illustrating an example of the display screen by the ECU included in the vehicle according to the second embodiment; and

FIG. 16 is a view illustrating an example of the display screen by the ECU included in the vehicle according to the second embodiment.

### DETAILED DESCRIPTION

Hereinafter, exemplary embodiments disclosed here will be disclosed. A configuration of the embodiments described below and actions, results, and effects caused by the configuration are given by way of example. The disclosure may be realized by a configuration other than the configuration disclosed in the following embodiments, and at least one of various effects based on a basic configuration and derivative effects may be obtained.

A vehicle equipped with a periphery monitoring device according to the present embodiment may be an automobile (an internal combustion engine automobile) having an internal combustion engine (an engine) as a driving source, an automobile (an electric automobile, a fuel cell car, or the like) having an electric motor (a motor) as a driving source, or an automobile (a hybrid automobile) having both of them as a driving source. The vehicle may be equipped with various transmission devices, and various devices (systems, components, and the like) required for driving an internal combustion engine or an electric motor. The system, the number, and the layout of devices involved in driving wheels in the vehicle may be set in various ways.

### First Embodiment

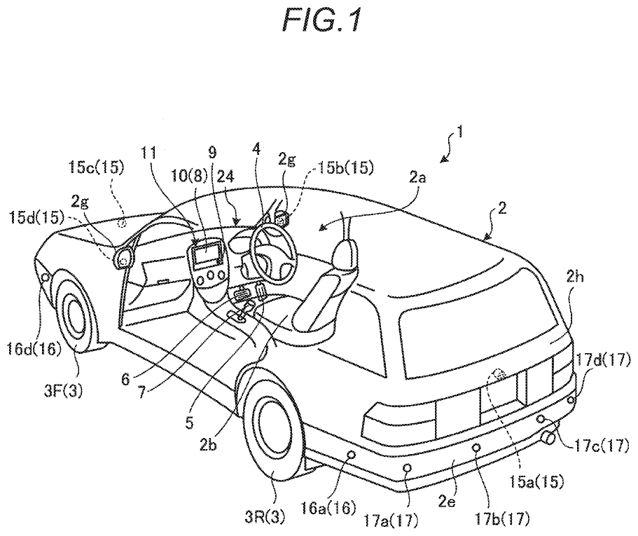

FIG. 1 is a perspective view illustrating an example of a state where a part of a vehicle cabin of a vehicle equipped with a periphery monitoring device according to a first embodiment is seen through. As illustrated in FIG. 1, the vehicle 1 includes a vehicle body 2, a steering unit 4, an acceleration operation unit 5, a braking operation unit 6, a speed-change operation unit 7, and a monitor device 11. The vehicle body 2 has a vehicle cabin 2a on which a passenger gets. In the vehicle cabin 2a, the steering unit 4, the acceleration operation unit 5, the braking operation unit 6, the speed-change operation unit 7, and the like are provided in a state where a driver as the passenger faces a seat 2b. The steering unit 4 is, for example, a steering wheel that protrudes from a dashboard 24. The acceleration operation unit 5 is, for example, an accelerator pedal that is located under the driver's feet. The braking operation unit 6 is, for example, a brake pedal that is located under the driver's feet. The speed-change operation unit 7 is, for example, a shift lever that protrudes from a center console.

The monitor device 11 is provided, for example, on the center portion of the dashboard 24 in the vehicle width direction (i.e., in the transverse direction). The monitor device 11 may have a function such as a navigation system or an audio system. The monitor device 11 includes a display device 8, a voice output device 9, and an operation input unit 10. Further, the monitor device 11 may have various operation input units such as a switch, a dial, a joystick, and a push button.

The display device 8 is constituted by a liquid crystal display (LCD) or organic electroluminescent display (OELD), and is capable of displaying various images based on image data. The voice output device 9 is constituted by a speaker and the like to output various types of voice based on voice data. The voice output device 9 may be provided at a different position other than the monitor device 11 in the vehicle cabin 2a.

The operation input unit 10 is constituted by a touch panel and the like, and enables a passenger to input various pieces of information. Further, the operation input unit 10 is provided on a display screen of the display device 8 and through which an image displayed on the display device 8 can transmits. Thus, the operation input unit 10 enables the passenger to visually recognize the image displayed on the display screen of the display device 8. The operation input unit 10 receives an input of various pieces of information by the passenger by detecting a touch operation of the passenger on the display screen of the display device 8.

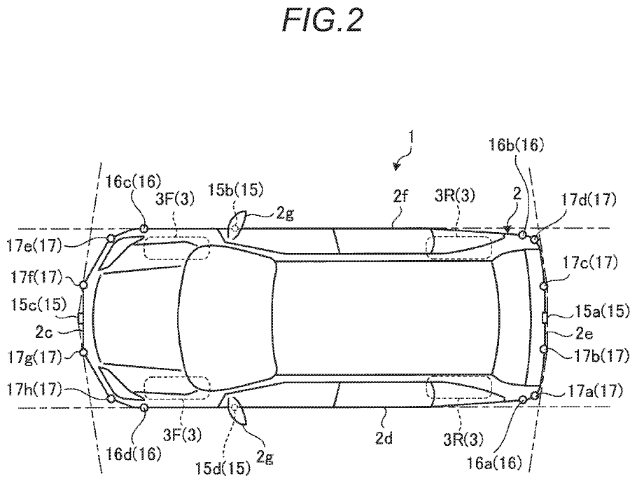

FIG. 2 is a plan view of an example of the vehicle according to the first embodiment. As illustrated in FIGS. 1 and 2, the vehicle 1 is a four-wheel vehicle or the like, and has two left and right front wheels 3F and two left and right rear wheels 3R. All or some of the four wheels 3 are steerable.

The vehicle 1 is equipped with a plurality of imaging units 15 (in-vehicle cameras). In the present embodiment, the vehicle 1 is equipped with, for example, four imaging units 15a to 15d. The imaging unit 15 is a digital camera having an imaging element such as a charge coupled device (CCD) or a CMOS image sensor (CIS). The imaging unit 15 is capable of capturing an image of the periphery of the vehicle 1 at a predetermined frame rate. Then, the imaging unit 15 outputs a captured image obtained by capturing the image of the periphery of the vehicle 1. Each imaging unit 15 has a wide-angle lens or a fish-eye lens, and is capable of capturing an image of, for example, a range from 140° to 220° in the horizontal direction. Further, the optical axis of the imaging unit 15 may be set obliquely downward.

Specifically, the imaging unit 15a is located, for example, on an end 2e at the rear side of the vehicle body 2 and is provided on a wall portion below a rear window of a rear hatch door 2h. Then, the imaging unit 15a is capable of capturing an image of an area behind the vehicle 1 among the periphery of the vehicle 1. The imaging unit 15b is located, for example, on an end 2f at the right side of the vehicle body 2 and is provided on a door mirror 2g at the right side. Then, the imaging unit 15b is capable of capturing an image of an area at the lateral side of the vehicle 1 among the periphery of the vehicle 1. The imaging unit 15c is located, for example, on the front side of the vehicle body 2, i.e., on an end 2c at the front side in the longitudinal direction of the vehicle 1 and is provided on a front bumper or a front grille. Then, the imaging unit 15c is capable of capturing an image in front of the vehicle 1 among the periphery of the vehicle 1. The imaging unit 15d is located, for example, on the left side of the vehicle body 2, i.e., on an end 2d at the left side in the vehicle width direction and is provided on a door mirror 2g at the left side. Then, the imaging unit 15d is capable of capturing an image of an area at the lateral side of the vehicle 1 among the periphery of the vehicle 1.

The vehicle 1 includes a plurality of radars 16 capable of measuring distances to objects present outside the vehicle 1. The radar 16 is a millimeter waver radar or the like, and is capable of measuring a distance to an object present in the traveling direction of the vehicle 1. In the embodiment, the vehicle 1 includes a plurality of radars 16a to 16d. The radar 16c is provided at a right end of the front bumper of the vehicle 1, and is capable of measuring a distance to an object present at the right front side of the vehicle 1. The radar 16d is provided at a left end of the front bumper of the vehicle 1, and is capable of measuring a distance to an object present at the left front side of the vehicle 1. The radar 16b is provided at a right end of a rear bumper of the vehicle 1, and is capable of measuring a distance to an object present at the right rear side of the vehicle 1. The radar 16a is provided at a left end of the rear bumper of the vehicle 1, and is capable of measuring a distance to an object present at the left rear side of the vehicle 1.

The vehicle 1 includes a sonar 17 capable of measuring a distance to an external object present at a short distance from the vehicle 1. In the embodiment, the vehicle 1 includes a plurality of sonars 17a to 17h. The sonars 17a to 17d are provided on the rear bumper of the vehicle 1, and are capable of measuring a distance to an object present behind the vehicle. The sonars 17e to 17h are provided on the front bumper of the vehicle 1, and are capable of measuring a distance to an object present in front of the vehicle 1.

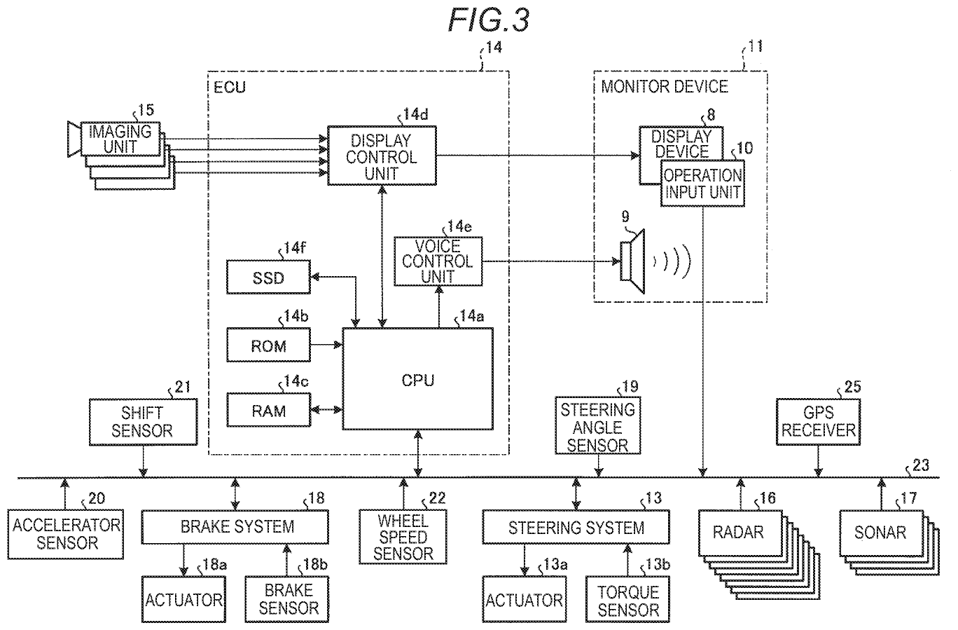

FIG. 3 is a block diagram illustrating an example of a functional configuration of the vehicle according to the first embodiment. As illustrated in FIG. 3, the vehicle 1 includes a steering system 13, a brake system 18, a steering angle sensor 19, an accelerator sensor 20, a shift sensor 21, a wheel speed sensor 22, a global positioning system (GPS) receiver 25, an in-vehicle network 23, and an electronic control unit (ECU) 14. The monitor device 11, the steering system 13, the radar 16, the sonar 17, the brake system 18, the steering angle sensor 19, the accelerator sensor 20, the shift sensor 21, the wheel speed sensor 22, the GPS receiver 25, and the ECU 14 are electrically connected to each other via the in-vehicle network 23 that is an electric communication line. The in-vehicle network 23 is constituted by a controller area network (CAN), or the like.

The steering system 13 is an electric power steering system or a steer by wire (SBW) system. The steering system 13 includes an actuator 13a and a torque sensor 13b. Then, the steering system 13 is electrically controlled by the ECU 14 and the like to operate the actuator 13a and apply a torque to the steering unit 4 so as to compensate for a steering force, thereby steering the wheel 3. The torque sensor 13b detects torque given to the steering unit 4 by the driver, and transmits the detection result to the ECU 14.

The brake system 18 includes an anti-lock brake system (ABS) that controls locking of a brake of the vehicle 1, an electronic stability control (ESC) that suppresses the side slipping of the vehicle 1 during cornering, an electric brake system that increases a braking force to assist the brake, and a brake by wire (BBW). The brake system 18 includes an actuator 18a and a brake sensor 18b. The brake system 18 is electrically controlled by the ECU 14 and the like to apply a braking force to the wheel 3 via the actuator 18a. The brake system 18 detects locking of the brake, idle rotation of the wheel 3, a sign of side slipping, and the like from the difference in the rotation of the left and right wheels 3 to execute control for prevention of the locking of the brake, the idle rotation of the wheel 3, and the side slipping. The brake sensor 18b is a displacement sensor that detects the position of a brake pedal as a movable element of the braking operation unit 6, and transmits the detection result of the position of the brake pedal to the ECU 14.

The steering angle sensor 19 is a sensor that detects the amount of steering of the steering unit 4 such as a steering wheel. In the present embodiment, the steering angle sensor 19 is constituted by a Hall element and the like, and detects the rotation angle of a rotating element of the steering unit 4 as the amount of steering and transmits the detection result to the ECU 14. The accelerator sensor 20 is a displacement sensor that detects the position of an accelerator pedal as a movable element of the acceleration operation unit 5 and transmits the detection result to the ECU 14. The GPS receiver 25 acquires a current position of the vehicle 1 based on radio waves received from an artificial satellite.

The shift sensor 21 is a sensor that detects the position of a movable element (e.g., a bar, an arm, or a button) of the transmission operation unit 7 and transmits the detection result to the ECU 14. The wheel speed sensor 22 is a sensor that includes a hall element and the like, and detects the amount of rotation of the wheel 3 or the number of revolutions per unit time of the wheel 3 and transmits the detection result to the ECU 14.

The ECU 14 is constituted by a computer and the like, and controls the entire control of the vehicle 1 by cooperation of hardware and software. Specifically, the ECU 14 includes a central processing unit (CPU) 14a, a read only memory (ROM) 14b, a random access memory (RAM) 14c, a display control unit 14d, a voice control unit 14e, and a solid state drive (SSD) 14f. The CPU 14a, the ROM 14b, and the RAM 14c may be provided on the same circuit board.

The CPU 14a reads a program stored in a non-volatile storage device such as the ROM 14b, and executes various arithmetic processings according to the program. For example, the CPU 14a executes an image processing on image data to be displayed on the display device 8, control of driving of the vehicle 1 along a target route to a target position such as a parking position and the like.

The ROM 14b stores various programs and parameters required for the execution of the programs. The RAM 14c temporarily stores various data used in the calculation in the CPU 14a. The display control unit 14d mainly executes an image processing on image data acquired from the imaging unit 15 to output the image data to the CPU 14a, conversion from the image data acquired from the CPU 14a to display image data to be displayed on the display device 8, and the like, among the arithmetic processings in the ECU 14. The voice control unit 14e mainly executes a processing of voice acquired from the CPU 14a and output to the voice output device 9 among the arithmetic processings in the ECU 14. The SSD 14f is a rewritable non-volatile storage unit, and continuously stores data acquired from the CPU 14a even when the ECU 14 is powered off.

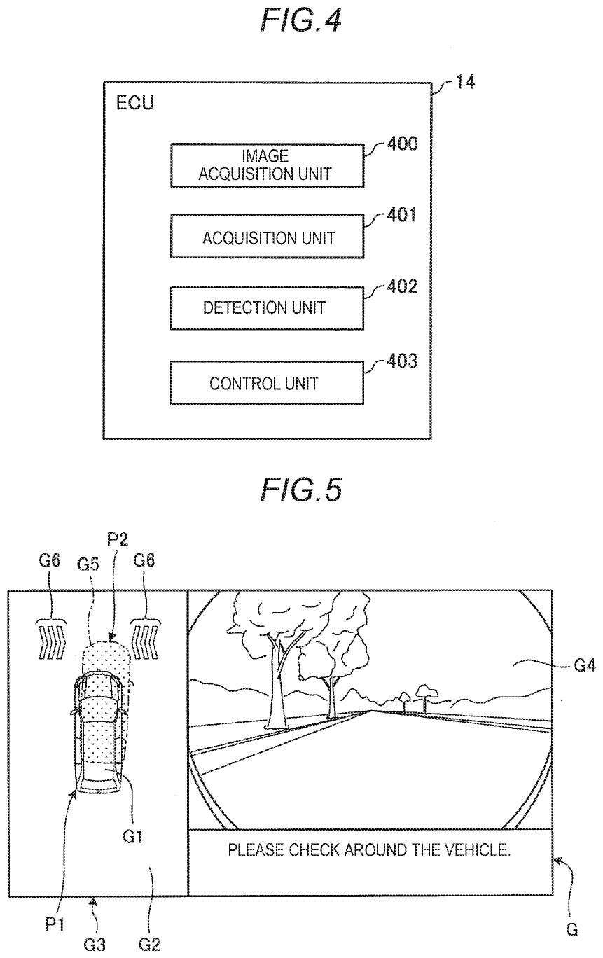

FIG. 4 is a block diagram illustrating an example of a functional configuration of the ECU included in the vehicle according to the first embodiment. As illustrated in FIG. 4, the ECU 14 includes an image acquisition unit 400, an acquisition unit 401, a detection unit 402, and a control unit 403. For example, when a processor such as the CPU 14a mounted on a circuit board executes a periphery monitoring program stored in a storage medium such as the ROM 14b or the SSD 14f, the ECU 14 realizes functions of the image acquisition unit 400, the acquisition unit 401, the detection unit 402, and the control unit 403. A part or all of the image acquisition unit 400, the acquisition unit 401, the detection unit 402, and the control unit 403 may be constituted by hardware such as circuits.

The image acquisition unit 400 acquires a captured image obtained by imaging the periphery of the vehicle 1 by the imaging unit 15. The acquisition unit 401 acquires a current steering angle of the vehicle 1. In the embodiment, the acquisition unit 401 acquires a steering amount detected by the steering angle sensor 19, as the current steering angle of the vehicle 1.

The detection unit 402 is capable of detecting an object that may come in contact with the vehicle 1. In the embodiment, the detection unit 402 detects an object that may come in contact with the vehicle 1 based on a captured image obtained by imaging in the traveling direction of the vehicle 1 by the imaging unit 15, a distance measured by the radar 16 (a distance between the vehicle 1, and an object present in the traveling direction of the vehicle 1), and the like. In the embodiment, the detection unit 402 detects both a stationary object that may come in contact with the vehicle 1, and a moving object that may come close to the vehicle 1 and may come in contact with the vehicle, as objects that may come in contact with the vehicle 1.

For example, the detection unit 402 detects an object that may come in contact with the vehicle 1 by an image processing (e.g., an optical flow) on the captured image obtained by imaging by the imaging unit 15. Otherwise, the detection unit 402 detects an object that may come in contact with the vehicle 1 based on a change in a distance measured by the radar 16.

In the embodiment, the detection unit 402 detects an object that may come in contact with the vehicle 1 based on the captured image obtained by imaging by the imaging unit 15 or the measurement result of the distance by the radar 16. Meanwhile, when an object present at a relatively short distance from the vehicle 1 is detected, it is also possible to detect an object that may come in contact with the vehicle 1 based on the measurement result of the distance by the sonar 17.

In the embodiment, the detection unit 402 shifts to an operating state (ON) or a non-operating state (OFF) according to the operation of a main switch (not illustrated) included in the vehicle 1. Here, the operating state is a state where an object that may come in contact with the vehicle 1 is detected. Meanwhile, the non-operating state is a state where an object that may come in contact with the vehicle 1 is not detected.

In the embodiment, the detection unit 402 shifts to the operating state or the non-operating state according to the operation of the main switch, but the present disclosure is not limited thereto. For example, the detection unit 402 may automatically shift to the operating state (not by the operation of the main switch) when the speed of the vehicle 1 is equal to or lower than a preset speed (e.g., 12 km/h) based on the detection result of the rotational speed of the wheels 3 by the wheel speed sensor 22, and the like. The detection unit 402 may automatically shift to the non-operating state (not by the operation of the main switch) when the speed of the vehicle 1 is higher than the preset speed.

The control unit 403 causes the display device 8 to display a display screen including a captured image obtained by imaging in the traveling direction of the vehicle 1 by the imaging unit 15, and a composite image including a vehicle image and a peripheral image, via the display control unit 14d. Although in the embodiment, the control unit 403 causes the display device 8 to display the display screen including the composite image and the captured image, the control unit 403 only has to cause the display device 8 to display a display screen including at least the composite image. Therefore, for example, the control unit 403 may cause the display device 8 to display a display screen including the composite image without including the captured image.

Here, the vehicle image is an image illustrating the vehicle 1. In the embodiment, the vehicle image is a bird's eye view image when the vehicle 1 is viewed from above. Accordingly, it is possible to exactly grasp the positional relationship between the vehicle 1 and an object in the vicinity thereof. In the embodiment, the vehicle image may be an image in a bitmap format, or an image that illustrates the shape of a vehicle and is constituted by a plurality of polygons. Here, the vehicle image constituted by the plurality of polygons is the shape of the three-dimensional vehicle 1, which is expressed by the plurality of polygons (in the embodiment, triangular polygons).

The peripheral image is an image illustrating the periphery (surroundings) of the vehicle 1, which is generated based on the captured image obtained by imaging the surroundings of the vehicle 1 by the imaging unit 15. In the embodiment, the peripheral image is a bird's eye view image when the periphery (surroundings) of the vehicle 1 is viewed from above. In the embodiment, the peripheral image is a bird's eye view image of the periphery of the vehicle 1, which is centered on the center of a rear wheel shaft of the vehicle image.

When the detection unit 402 is in an operating state, the control unit 403 displays a virtual vehicle image that is superimposed at a position where the vehicle 1 exists when travels by a predetermined distance at a current steering angle acquired by the acquisition unit 401, based on a position of the vehicle 1 illustrated by the vehicle image in the composite image. Meanwhile, when the detection unit 402 is in a non-operating state, the control unit 403 does not display the virtual vehicle image. Accordingly, on the basis of whether the virtual vehicle image is included in the display screen displayed on the display device 8, the driver of the vehicle 1 may easily recognize whether the detection unit 402 is in the operating state, from the display screen displayed on the display device 8.

Here, the predetermined distance is a preset distance, and ranges from, for example, 1.0 m to 2.0 m. The current steering angle is a steering angle at a current position of the vehicle 1. In the embodiment, the control unit 403 acquires a steering angle acquired by the acquisition unit 401, as the steering angle at the current position of the vehicle 1.

The virtual vehicle image is a virtual image illustrating the shape of the vehicle 1. In the embodiment, the virtual vehicle image is an image that illustrates the shape of the vehicle 1 and is constituted by a plurality of polygons. Here, the virtual vehicle image constituted by the plurality of polygons is the shape of the three-dimensional vehicle 1 (the three-dimensional shape of the vehicle 1), which is expressed by the plurality of polygons (in the embodiment, triangular polygons). Accordingly, a more realistic virtual vehicle image may be displayed on the display device 8.

Although in the embodiment, the control unit 403 causes the composite image to include the image that illustrates the shape of the vehicle 1 and is constituted by the plurality of polygons, as the virtual vehicle image, it is also possible to cause the composite image to include, for example, an image illustrating the shape of the vehicle 1 in a bitmap format, as the virtual vehicle image.

In the embodiment, when the detection unit 402 is in the operating state and the shift sensor 21 detects that the position of the speed-change operation unit 7 falls within a D range, the control unit 403 displays the virtual vehicle image in front of the vehicle 1. This informs the driver that it is possible to detect an approaching object in front of the vehicle 1.

Meanwhile, when the detection unit 402 is in the operating state and the shift sensor 21 detects that the position of the speed-change operation unit 7 falls within an R range, the control unit 403 displays the virtual vehicle image behind the vehicle 1. This informs the driver that it is possible to detect an object approaching from the rear of the vehicle 1.

When an object that may come in contact with the vehicle 1 is not detected by the detection unit 402, the control unit 403 keeps displaying the virtual vehicle image that is superimposed at a position where the vehicle 1 exists when travels by a predetermined distance at a current steering angle, based on the position of the vehicle 1 illustrated by the vehicle image in the composite image. That is, when an object that may come in contact with the vehicle 1 is not detected by the detection unit 402, as the vehicle 1 moves, the control unit 403 also moves the position of the virtual vehicle image in the composite image.

Meanwhile, when an object that may come in contact with the vehicle 1 is detected by the detection unit 402, the control unit 403 changes a display mode of an image of a portion in the virtual vehicle image coming in contact with the detected object (hereinafter, referred to as a partial image). This allows the driver of the vehicle 1 to recognize the position in the vehicle body of the vehicle 1 that may come in contact with the object, from the virtual vehicle image, in driving the vehicle 1, and thus, to easily avoid the contact between the detected object and the vehicle 1.

In the embodiment, the control unit 403 changes a display mode of the partial image into a mode different from that of other portions of the virtual vehicle image by causing the partial image to blink, changing the color, or highlighting the contour of the partial image. In the embodiment, when the virtual vehicle image is constituted by polygons, the control unit 403 specifies a polygon of the portion coming in contact with the object, as the partial image, among the polygons constituting the virtual vehicle image. Then, the control unit 403 changes the display mode of the specified polygon.

When an object that may come in contact with the vehicle 1 is detected, the control unit 403 moves the virtual vehicle image to a contact position where the vehicle 1 comes in contact with the object in the composite image, and then, does not move the virtual vehicle image from the contact position. In the embodiment, when an object that may come in contact with the vehicle 1 is detected, the control unit 403 fixes the virtual vehicle image without movement from the contact position where the vehicle 1 comes in contact with the object in the composite image, but the present disclosure is not limited thereto. For example, the control unit 403 may stop the movement of the virtual vehicle image at a position before the contact position, and may fix the virtual vehicle image without movement from the position. That is, the control unit 403 displays the virtual vehicle image that is superimposed at a position where the vehicle 1 exists when travels to the contact position where the vehicle 1 comes in contact with the object, or the position where the vehicle 1 is not yet in contact with the object, as a position where the vehicle 1 exists when travels by a predetermined distance. This allows the driver of the vehicle 1 to easily recognize at which position the vehicle 1 may come in contact with the object.

In the embodiment, after an object that may come in contact with the vehicle 1 is detected and the virtual vehicle image is fixed at the contact position, in a case where the driver of the vehicle 1 changes the traveling direction of the vehicle 1 by steering the steering unit 4 and the detection unit 402 no longer detects the object that may come in contact with the vehicle 1, the control unit 403 releases the fixing of the virtual vehicle image at the contact position. Then, the control unit 403 moves the position of the virtual vehicle image again in the composite image as the vehicle 1 moves.

When the detection unit 402 is in the operating state, the control unit 403 displays an approaching object index with respect to the traveling direction of the vehicle 1 illustrated by the vehicle image in the composite image. This allows the driver of the vehicle 1 to easily recognize whether the detection unit 402 is in the operating state from the display screen displayed on the display device 8 based on whether the approaching object index is included in the display screen displayed on the display device 8.

Here, the approaching object index is an index that enables identification of the direction in which an object approaches the vehicle 1 (hereinafter, referred to as an approaching direction). In the embodiment, the approaching object index is an arrow indicating the approaching direction. In the embodiment, the approaching object index is an index that enables identification of the approaching direction of a moving object among objects that may come in contact with the vehicle 1.

Then, when an object approaching the vehicle 1 is detected by the detection unit 402, the control unit 403 changes a display mode of the approaching object index. Accordingly, the driver of the vehicle 1 may easily recognize from which direction the object that may come in contact with the vehicle 1 is approaching by visually recognizing the approaching object index whose display mode is changed. In the embodiment, the control unit 403 makes the display mode of the approaching object index different from a display mode of the approaching object index in a case where the object approaching the vehicle 1 is not detected by changing the color of the approaching object index or causing the approaching object index to blink.

In the embodiment, when a stationary object is detected as an object that may come in contact with the vehicle 1, the control unit 403 changes a display mode of the partial image in the virtual vehicle image, and when a moving object is detected as an object that may come in contact with the vehicle 1, the control unit 403 changes a display mode of the approaching object index. However, it is also possible to change the display mode of the partial image in the virtual vehicle image when the moving object is detected as an object that may come in contact with the vehicle 1. In this case, the control unit 403 may cause the composite image to include the approaching object index, or may not cause the composite image to include the approaching object index.

Next, descriptions will be made on specific examples of the display screen displayed on the display device 8 by the control unit 403, with reference to FIGS. 5 to 12.

FIG. 5 is a view illustrating a display example of the display screen by the ECU included in the vehicle according to the first embodiment. Here, descriptions will be made on a display processing of the display screen in a case where the shift sensor 21 detects that the position of the speed-change operation unit 7 falls within a D range. In the embodiment, as illustrated in FIG. 5, the control unit 403 causes the display device 8 to display a display screen G that includes a composite image G3 including a vehicle image G1 and a peripheral image G2, and a captured image G4 obtained by imaging in the traveling direction of the vehicle 1 by the imaging unit 15 (e.g., in front of the vehicle 1).

Then, when the detection unit 402 is in an operating state, as illustrated in FIG. 5, the control unit 403 displays a virtual vehicle image G5 that is superimposed at a position P2 in a case where the vehicle 1 travels by a predetermined distance at a steering angle (a steering angle acquired by the acquisition unit 401) at a current position P1, based on a position of the vehicle 1 illustrated by the vehicle image G1 in the peripheral image G2. Here, as illustrated in FIG. 5, the virtual vehicle image G5 is a semi-transparent image illustrating the shape of the vehicle 1. This allows the driver of the vehicle 1 to easily distinguish the virtual vehicle image G5 from the vehicle image G1, and to intuitively recognize that the virtual vehicle image G5 is an image illustrating a future position P2 of the vehicle 1.

In the embodiment, the control unit 403 displays an image in which the transmittance increases from the contour of the vehicle 1 toward the inside, as the virtual vehicle image G5. This allows the driver of the vehicle 1 to easily distinguish the virtual vehicle image G5 from the vehicle image G1, and makes it easy for the driver to more intuitively recognize that the virtual vehicle image G5 is an image illustrating a future position of the vehicle 1.

The control unit 403 may display the contour of the virtual vehicle image G5 in a display mode different from that of other portions of the virtual vehicle image G5 (e.g., a different color, blinking, superimposing of a frame border) so as to highlight the contour. This allows the driver of the vehicle 1 to easily recognize a future position of the vehicle 1 from the virtual vehicle image G5.

When the detection unit 402 is in an operating state, as illustrated in FIG. 5, the control unit 403 displays approaching object indices G6, at preset positions based on the position of the virtual vehicle image G5 (e.g., on the right and left sides of the virtual vehicle image G5) in the traveling direction of the vehicle 1 (e.g., in front of the vehicle 1), in the peripheral image G2. Here, in the embodiment, the control unit 403 displays the approaching object index G6 in the grayscale.

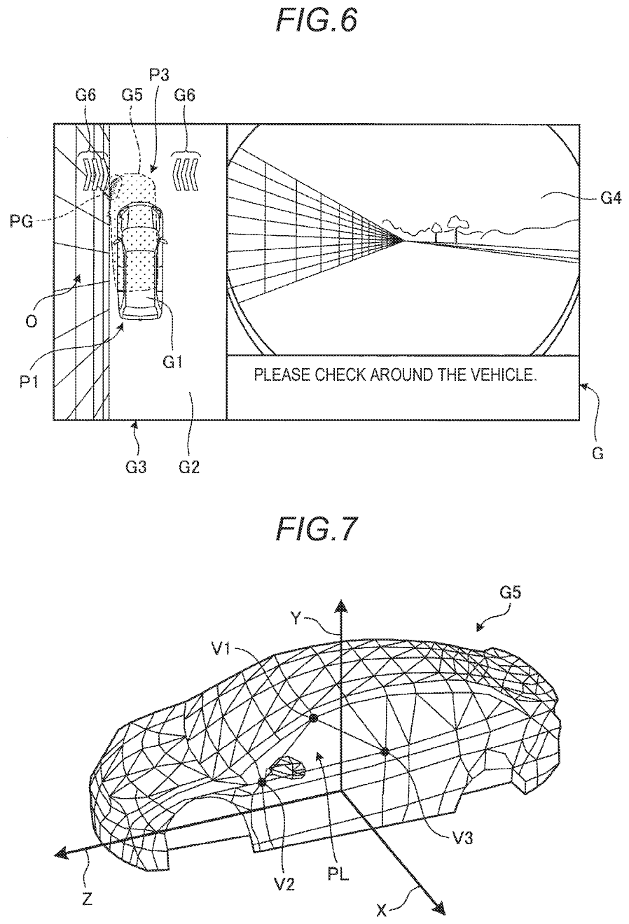

FIG. 6 is a view illustrating a display example of the display screen by the ECU included in the vehicle according to the first embodiment. In the embodiment, when an object that may come in contact with the vehicle 1 is not detected by the detection unit 402, as illustrated in FIG. 5, as the vehicle 1 moves, the control unit 403 also moves the position of the virtual vehicle image G5 in the peripheral image G2. Meanwhile, when an object O (e.g., a wall or a fence) that may come in contact with the vehicle 1 is detected by the detection unit 402, as illustrated in FIG. 6, the control unit 403 moves the virtual vehicle image G5 to a contact position P3 where the vehicle 1 comes in contact with the detected object O, in the peripheral image G2. Then, as illustrated in FIG. 6, even when the vehicle 1 moves, the control unit 403 fixes the virtual vehicle image G5 without movement from the contact position P3.

Here, as illustrated in FIG. 6, the control unit 403 makes the display mode of a partial image PG in the virtual vehicle image G5 coming in contact with the detected object O different from the display mode of other portions of the virtual vehicle image G5. For example, the control unit 403 displays the partial image PG in red, and displays portions other than the partial image PG in the virtual vehicle image G5, in white. Accordingly, when driving the vehicle 1 at a current steering angle, the driver of the vehicle 1 may grasp the position in the vehicle body 2 of the vehicle 1 that may come in contact with the detected object O, and thus, may more easily drive the vehicle 1 while preventing the vehicle 1 from coming in contact with the detected object O.

In the embodiment, the control unit 403 is also capable of changing the display mode of the partial image PG according to a distance between the position of the detected object O and the current position P1 of the vehicle 1 illustrated by the virtual vehicle image G5. Accordingly, it is possible to grasp the positional relationship between the vehicle 1 and the object O in more detail by checking a change in the display mode of the partial image PG. Thus, it is possible to more easily drive the vehicle 1 while preventing the vehicle 1 from coming in contact with the detected object O. Specifically, the control unit 403 highlights the partial image PG by increasing the redness of the partial image PG displayed in red, or causing the partial image PG to blink as the distance between the position of the detected object O and the current position P1 of the vehicle 1 illustrated by the virtual vehicle image G5 decreases.

Meanwhile, the control unit 403 releases the highlighting of the partial image PG by decreasing the redness of the partial image PG or widening the blinking interval of the partial image PG as the distance between the position of the detected object O and the current position P1 of the vehicle 1 illustrated by the virtual vehicle image G5 increases. Then, in a case where the driver of the vehicle 1 changes the traveling direction of the vehicle 1 by steering the steering unit 4 and the detection unit 402 no longer detects the object O that may come in contact with the vehicle 1, the control unit 403 returns the display mode of the partial image PG, into the same display mode as that of other portions of the virtual vehicle image G5. The control unit 403 releases the fixing of the virtual vehicle image G5 at the contact position P3, and then moves the position of the virtual vehicle image G5 again in the composite image G3 as the vehicle 1 moves.

Here, since it is assumed that the object O detected by the detection unit 402 is a stationary object such as a wall or a fence, the control unit 403 changes the display mode of the partial image PG in the virtual vehicle image G5 but does not change the display mode of the approaching object index G6. Accordingly, the driver of the vehicle 1 may identify whether the object detected by the detection unit 402 is a stationary object or a moving object approaching the vehicle 1.

In the embodiment, the control unit 403 displays a display mode of the approaching object index G6, in the grayscale that is a display mode of the approaching object index G6 in a case where a moving object that may come in contact with the vehicle 1 is not detected by the detection unit 402. Meanwhile, when the object detected by the detection unit 402 is a moving object such as another vehicle or a pedestrian, the control unit 403 changes the display mode of the approaching object index G6 present in the direction in which the detected moving object is detected, among the approaching object indices G6 included in the peripheral image G2. Here, while changing the display mode of the approaching object index G6, the control unit 403 may also change the display mode of the partial image PG in the virtual vehicle image G5 which comes in contact with the detected moving object.

Meanwhile, when the object detected by the detection unit 402 is a moving object approaching the vehicle 1, as described above, the control unit 403 changes the display mode of the approaching object index G6 present in the direction in which the detected object approaches, among the approaching object indices G6. For example, the control unit 403 changes the color of the approaching object index G6 present in the direction in which the detected object approaches, into a yellow color or the like, or causes the approaching object index G6 to blink. Otherwise, when each approaching object index G6 includes a plurality of arrows, the control unit 403 may display a plurality of arrows included in the approaching object index G6 displayed in the direction in which the detected moving object is present, by animation in which the display mode changes in order from an arrow farthest from the virtual vehicle image G5.

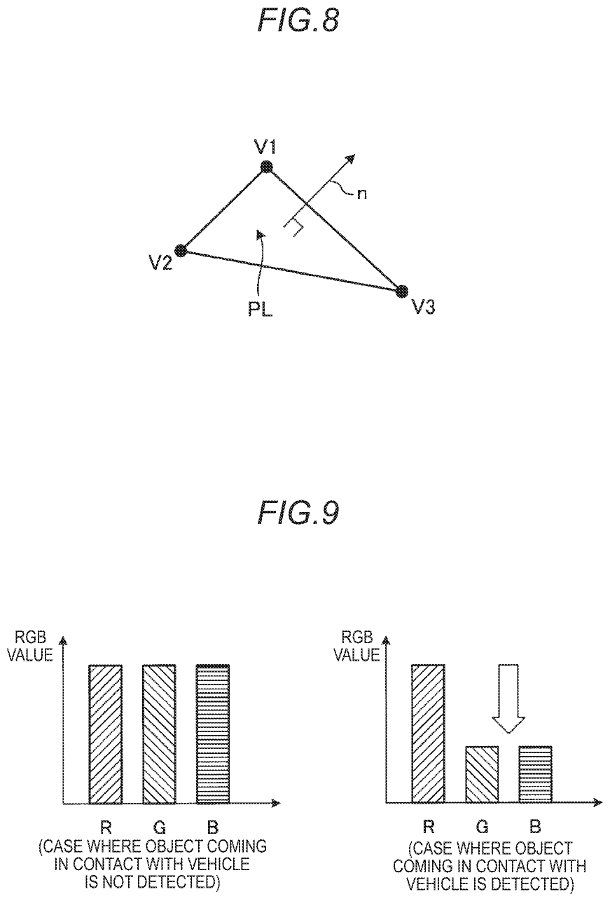

FIG. 7 and FIG. 8 are views for explaining an example of a method of displaying the virtual vehicle image by the ECU included in the vehicle according to the first embodiment. In FIG. 7, the X axis is an axis corresponding to the vehicle width direction of the vehicle 1, the Z axis is an axis corresponding to the traveling direction of the vehicle 1, and the Y axis is an axis corresponding to the height direction of the vehicle 1. When the virtual vehicle image G5 is constituted by a plurality of polygons PL, as illustrated in FIG. 7 and FIG. 8, the control unit 403 obtains a value (hereinafter, referred to as a Y component) of a normal vector n of vertices V1, V2, and V3 included in each polygon PL in the Y axis direction (a direction perpendicular to the road surface). Then, the control unit 403 determines the transmittance of the polygon PL based on the Y component of the normal vector n.

Specifically, the control unit 403 obtains the Y component of the normal vector n of the vertices V1, V2, and V3 included in the polygon PL. Next, the control unit 403 determines pixels included in the polygon PL based on the Y component of the normal vector n of the vertices V1, V2, and V3. Here, the control unit 403 increases the transmittance as the Y component of the normal vector n is increased. Thus, the control unit 403 is capable of displaying an image in which the transmittance is increased from the contour of the vehicle 1 toward the inside, as the virtual vehicle image G5. In the embodiment, the color of pixels constituting the polygon PL is white, but is not limited thereto. For example, it is also possible to set any color such as the color of the body of the vehicle 1.

FIG. 9 is a view for explaining an example of a method of determining a color of polygons constituting the virtual vehicle image by the ECU included in the vehicle according to the first embodiment. In FIG. 9, the horizontal axis indicates the types (e.g., RGB) of colors constituting vertices included in polygons constituting the virtual vehicle image, and the vertical axis indicates the values (e.g., RGB values) of the colors constituting vertices included in the polygons constituting the virtual vehicle image. In the embodiment, when an object that may come in contact with the vehicle 1 is detected by the detection unit 402, the control unit 403 makes the display mode of the partial image in the virtual vehicle image coming in contact with the detected object, different from the display mode of other portions of the virtual vehicle image.

Specifically, when an object that may come in contact with the vehicle 1 is not detected by the detection unit 402, as illustrated in FIG. 9, the control unit 403 equalizes the values of the RGB colors of each vertex included in the polygons constituting the virtual vehicle image. Then, based on the values of the RGB colors of each vertex included in the polygons, the control unit 403 determines the color of the entire polygon by interpolating the color of an area in the polygon surrounded by the vertices through linear interpolation and the like. Accordingly, the control unit 403 displays the virtual vehicle image, in white.

Meanwhile, when an object that may come in contact with the vehicle 1 is detected by the detection unit 402, as illustrated in FIG. 9, the control unit 403 makes the GB values of each vertex included in the polygons constituting the partial image, among the polygons constituting the virtual vehicle image, smaller than the R value of each vertex. In this case as well, based on the values of the RGB colors of each vertex included in the polygons, the control unit 403 determines the color of the entire polygon by interpolating the color of an area in the polygon surrounded by the vertices through linear interpolation and the like. Accordingly, the control unit 403 displays the partial image, in red.

In the embodiment, the control unit 403 makes the GB values of each vertex included in the polygons constituting the partial image smaller than the R value of each vertex and displays the partial image in red so as to highlight the partial image, but the present disclosure is not limited thereto. For example, the control unit 403 may make the RB values of each vertex included in the polygons constituting the partial image, smaller than the G value of each vertex, and may display the partial image in green in order to highlight the partial image.

Here, the control unit 403 is also capable of reducing the GB values of each vertex included in the polygons constituting the partial image as the distance between the position of the detected object and the position of the vehicle 1 illustrated by the virtual vehicle image decreases. Accordingly, the control unit 403 highlights the partial image by increasing the redness of the partial image. This makes it possible to easily recognize a portion in the vehicle body of the vehicle 1 that may come in contact with the external object, allowing the driver of the vehicle 1 to easily avoid the contact with the external object. Meanwhile, the control unit 403 causes the values of the RGB colors of each vertex included in the polygons other than the partial image to be kept equal, among the polygons constituting the virtual vehicle image. Accordingly, the control unit 403 displays the polygons other than the partial image, in white.

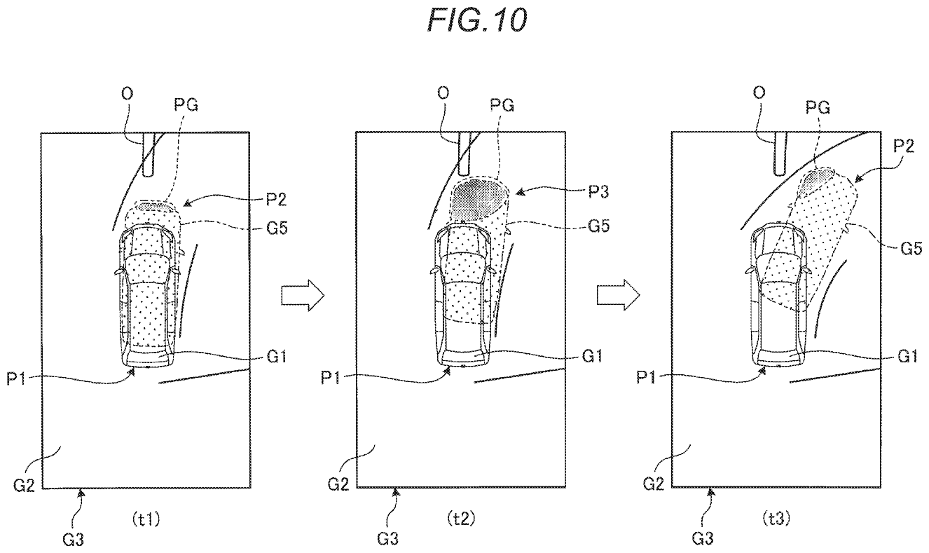

FIG. 10 is a view illustrating an example of the display screen by the ECU included in the vehicle according to the first embodiment. For example, as illustrated in FIG. 10, at time t1, when an object O (a stationary object) that may come in contact with the vehicle 1 is detected by the detection unit 402, the control unit 403 highlights the partial image PG in the virtual vehicle image G5 coming in contact with the detected object O, in red.

Specifically, the control unit 403 obtains the Euclidean distance from each vertex of the polygons constituting the partial image PG to the object O, in the XZ plane parallel to the road surface (see FIG. 7). Then, the control unit 403 makes the GB value of each vertex smaller than the R value of each vertex according to the Euclidean distance between each vertex of the polygons constituting the partial image PG and the object O. Then, the control unit 403 determines the color of pixels included in the polygons constituting the partial image PG by a fragment shader based on the RGB values of each vertex of the polygons constituting the partial image PG. Based on the values of the RGB colors of each vertex included in the polygons, the control unit 403 determines the color of the entire polygon by interpolating the color of an area in the polygon surrounded by the vertices, through linear interpolation and the like. Accordingly, the control unit 403 displays the partial image PG in red. When the RGB values of the polygons constituting the virtual vehicle image are calculated, the RGB values of the polygons constituting the partial image may be simultaneously calculated according to the distance between each vertex included in the polygons and the object. Accordingly, it is possible to generate the virtual vehicle image and the partial image without distinction.

Then, when the vehicle 1 continues to move and the virtual vehicle image G5 reaches the contact position P3 where the vehicle 1 comes in contact with the object O or the position immediately before the contact position P3, at time t2 after time t1, as illustrated in FIG. 10, the control unit 403 does not move the virtual vehicle image G5 from the contact position P3, and continues to display the virtual vehicle image G5 at the contact position P3.

Then, until time t3 after time t2, when the steering angle of the vehicle 1 is changed and there is no possibility that the vehicle 1 comes in contact with the object O (i.e., when the detection unit 402 no longer detects the object O), as illustrated in FIG. 10, the control unit 403 releases the fixing of the virtual vehicle image G5 at the contact position P3, and displays the virtual vehicle image G5 at the position P2 in a case where the vehicle 1 travels by a predetermined distance based on the position of the vehicle 1 illustrated by the vehicle image G1 at time t3.

Here, the control unit 403 may release the highlighting in which the partial image PG in the virtual vehicle image G5 is displayed in red. That is, at time t3, the control unit 403 returns the display mode of the partial image PG in the virtual vehicle image G5, into the same display mode as that of other portions of the virtual vehicle image G5. This allows the driver of the vehicle 1 to recognize that it is possible to avoid the contact with the object O at the current steering angle of the vehicle 1.

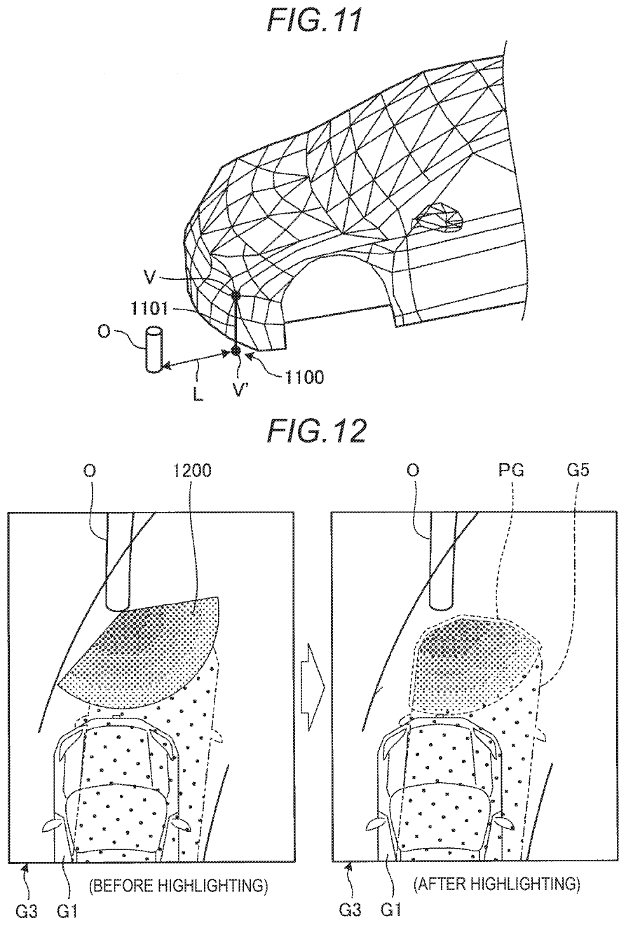

FIG. 11 and FIG. 12 are views for explaining an example of a processing of highlighting the partial image by the ECU included in the vehicle according to the first embodiment. In the embodiment, when the object O is detected by the detection unit 402, as illustrated in FIG. 11, first, the control unit 403 obtains a point V′ at which a perpendicular line 1101 from each vertex V included in the polygons constituting the partial image in the virtual vehicle image G5 to an XZ plane 1100 (the plane defined by the X axis and the Z axis illustrated in FIG. 7) intersects the XZ plane 1100. Then, the control unit 403 obtains a Euclidean distance L between the point V′ and the position of the object O, in the XZ plane 1100.

Next, the control unit 403 specifies the degree of highlighting corresponding to the obtained Euclidean distance L according to an intensity distribution 1200 illustrated in FIG. 12. Here, the intensity distribution 1200 is a distribution of the degrees of highlighting when the partial image is highlighted, and the degree of highlighting increases as the Euclidean distance L becomes shorter.

In the embodiment, the intensity distribution 1200 is a concentric intensity distribution in which the degree of highlighting is decreased and lowered as the Euclidean distance L increases with respect to the position of the object O as a center. In the embodiment, the intensity distribution 1200 is represented by a high-order curve in which the degree of highlighting sharply increases when the Euclidean distance L is equal to or lower than a preset distance (e.g., 1.7 m to 3.0 m). For example, the intensity distribution 1200 is an intensity distribution in which when the Euclidean distance L is equal to or lower than the preset distance, the GB values sharply decrease and R is emphasized.

Accordingly, as illustrated in FIG. 12, the control unit 403 highlights polygons whose Euclidean distances L to the object O are shorter, in red, among the polygons constituting the virtual vehicle image G5. As a result, as illustrated in FIG. 12, the control unit 403 is capable of highlighting the polygons constituting the partial image PG, in red, among the polygons constituting the virtual vehicle image G5.

As described above, in the vehicle 1 according to the first embodiment, based on whether the virtual vehicle image is included in the display screen displayed on the display device 8, the driver of the vehicle 1 may easily recognize whether the detection unit 402 is in the operating state, from the display screen displayed on the display device 8.

### Second Embodiment

The embodiment relates to an example in which a display screen including a three-dimensional image in the periphery of a vehicle, instead of a captured image obtained by imaging in the traveling direction of the vehicle by an imaging unit, is displayed on a display device. In the following description, the descriptions of the same configuration as that of the first embodiment will be omitted.

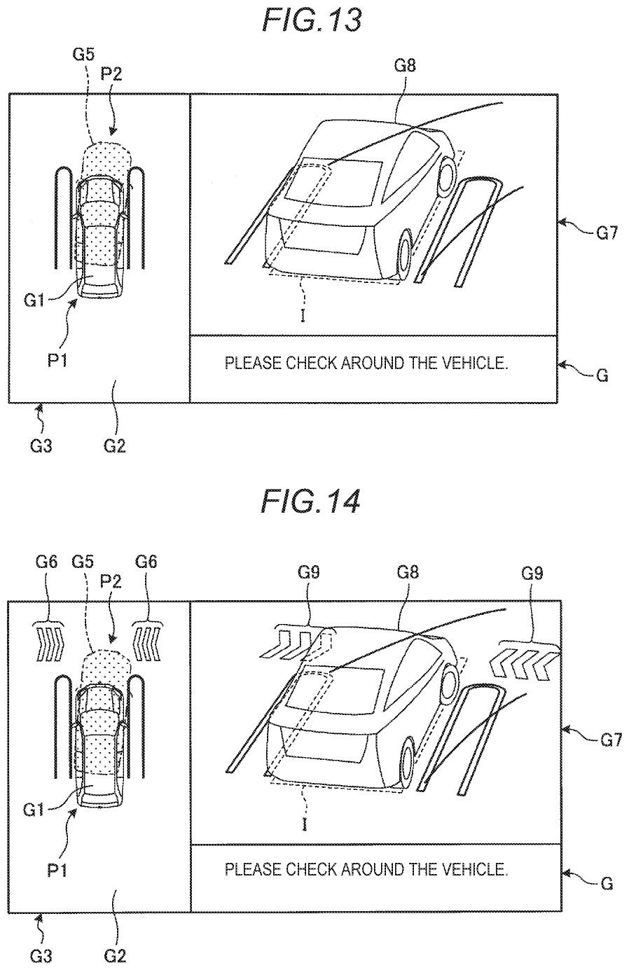

FIG. 13 and FIG. 14 are views illustrating an example of a display screen by an ECU included in a vehicle according to the second embodiment. In the embodiment, when the detection unit 402 is in a non-operating state, as illustrated in FIG. 13, the control unit 403 displays a display screen G including a composite image G3 and a three-dimensional image (hereinafter, referred to as a three-dimensional peripheral image) G7 of the vehicle 1 and the periphery thereof, on the display device 8. Accordingly, it is possible to visually recognize the three-dimensional peripheral image G7 as well as the composite image G3, and thus, to grasp the positional relationship between the vehicle 1 and an object in the vicinity thereof, in more detail.

Here, as described above, the three-dimensional peripheral image G7 is a three-dimensional image of the vehicle 1 and the periphery thereof. In the embodiment, the three-dimensional peripheral image G7 is an image that is generated by attaching an image obtained by imaging the periphery of the vehicle 1 by the imaging unit 15, to a bowl-like or cylindrical three-dimensional surface. In the embodiment, as illustrated in FIG. 13, the three-dimensional peripheral image G7 includes a three-dimensional vehicle image G8 that is a three-dimensional image of the vehicle 1. In the embodiment, like the virtual vehicle image G5, the three-dimensional vehicle image G8 is an image that illustrates the three-dimensional shape of the vehicle 1 and is constituted by a plurality of polygons.

In the embodiment, the control unit 403 displays vehicle position information I which makes it possible to identify the position of the three-dimensional vehicle image G8 with respect to the road surface in the three-dimensional peripheral image G7. For example, the vehicle position information I is information in which the position on the road surface in the three-dimensional peripheral image G7, where the three-dimensional vehicle image G8 is present, is displayed in the grayscale or by a line (e.g., a broken line) surrounding the position where the three-dimensional vehicle image G8 is present.

Then, when the detection unit 402 is in an operating state, as illustrated in FIG. 14, as in the first embodiment, the control unit 403 displays an approaching object index G6 in a peripheral image G2 and also displays an approaching object index G9 in the three-dimensional peripheral image G7. Here, as illustrated in FIG. 14, the control unit 403 displays the approaching object index G9 included in the three-dimensional peripheral image G7, in the grayscale. In the embodiment, the control unit 403 does not display the virtual vehicle image G5 in the three-dimensional peripheral image G7 so that the positional relationship between a vehicle image G1 and surrounding objects may be easily grasped, but the present disclosure is not limited thereto. It is also possible to display the virtual vehicle image G5 on the three-dimensional peripheral image G7.

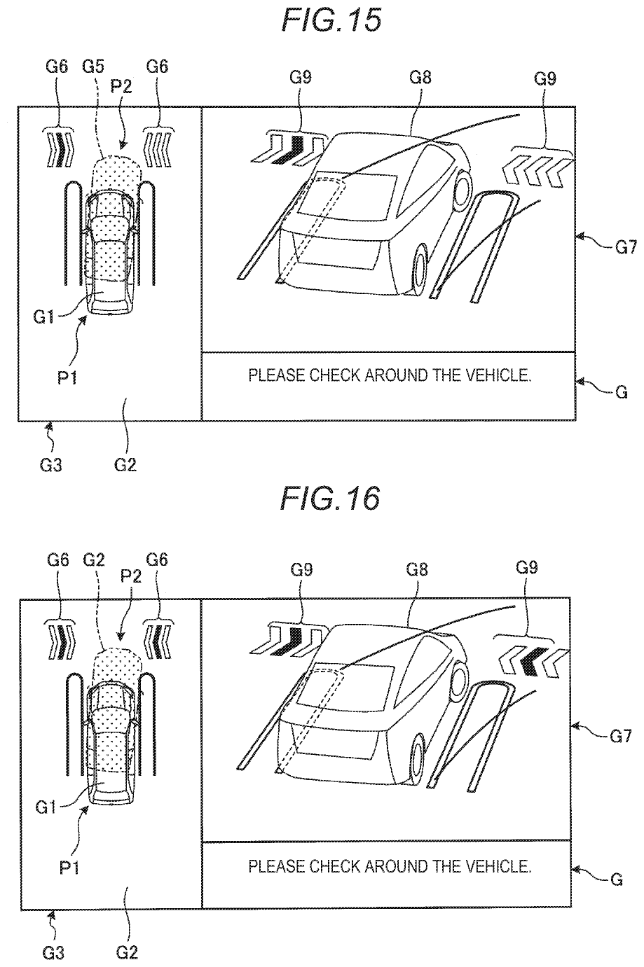

FIG. 15 and FIG. 16 are views illustrating an example of the display screen by the ECU included in the vehicle according to the second embodiment. In the embodiment, when the detection unit 402 detects an object coming close to the vehicle 1 (e.g., an object approaching from the left in the traveling direction of the vehicle 1), as illustrated in FIG. 15, the control unit 403 changes the display mode of the approaching object indices G6 and G9 present in the direction (e.g., on the left side) in which the detected object approaches, among the approaching object indices G6 included in the peripheral image G2 and the approaching object indices G9 included in the three-dimensional peripheral image G7.

When the detection unit 402 detects an object approaching from both the left and right sides in the traveling direction of the vehicle 1, as illustrated in FIG. 16, the control unit 403 changes the color of the display mode of the approaching object indices G6 and G9 present on both the left and right sides in the traveling direction of the vehicle 1 (e.g., the front side) into a yellow color or the like, or causes the approaching object indices G6 and G9 to blink. Otherwise, when each of the approaching object indices G6 and G9 includes a plurality of arrows, the control unit 403 may display a plurality of arrows included in each of the approaching object indices G6 and G9 displayed in the direction in which the detected moving object is present, by animation in which the display mode changes in order from an arrow farthest from the virtual vehicle image G5.

In the embodiment, when the detection unit 402 is in an operating state, the approaching object indices G6 and G9 are displayed in advance in the grayscale and the like. Thus, when the detection unit 402 detects an object coming close to the vehicle 1, and the display mode of the approaching object indices G6 and G9 is changed, the change of the display mode allows the driver of the vehicle 1 to easily recognize that the object coming close to the vehicle 1 is detected. In the embodiment, when the detection unit 402 is in the operating state, the control unit 403 displays both the virtual vehicle image G5 and the approaching object indices G6 and G9 on the display screen G, but at least the virtual vehicle image G5 may be displayed.

As described above, in the vehicle 1 according to the second embodiment, it is possible to visually recognize the three-dimensional peripheral image G7 as well as the composite image G3, and thus to grasp the positional relationship between the vehicle 1 and an object in the vicinity thereof in more detail.

A periphery monitoring device according to an aspect of this disclosure includes, as an example, an acquisition unit configured to acquire a current steering angle of a vehicle; an image acquisition unit configured to acquire a captured image from an imaging unit that images a periphery of the vehicle; and a control unit configured to cause a display unit to display a composite image including a vehicle image illustrating the vehicle, and a peripheral image illustrating the periphery of the vehicle based on the captured image, and cause the display unit to display a virtual vehicle image illustrating a shape of the vehicle superimposed at a position where the vehicle exists when travels by a predetermined distance at the current steering angle acquired by the acquisition unit based on a position of the vehicle illustrated by the vehicle image in the composite image when a detection unit capable of detecting an object coming in contact with the vehicle is in an operating state. Therefore, as an example, based on whether the virtual vehicle image is displayed on the display unit, a driver of the vehicle may easily recognize whether the detection unit is in the operating state, from an image displayed on the display unit.

In the periphery monitoring device according to the aspect of this disclosure, as an example, when the object is detected by the detection unit, the control unit may change a display mode of a partial image of a portion coming in contact with the object in the virtual vehicle image, and stop movement of the virtual vehicle image in the composite image at a contact position where the vehicle comes in contact with the object. As an example, this allows the driver of the vehicle to recognize the position in the vehicle body of the vehicle that may come in contact with the object, from the virtual vehicle image, in driving the vehicle, and thus to easily avoid the contact between the detected object and the vehicle.

In the periphery monitoring device according to the aspect of this disclosure, as an example, the virtual vehicle image may be an image that illustrates the shape of the vehicle and is constituted by polygons, and the partial image may be a polygon of the portion coming in contact with the object, among the polygons constituting the virtual vehicle image. As an example, this allows the driver of the vehicle to recognize the position in the vehicle body of the vehicle that may come in contact with the object, from the virtual vehicle image, in driving the vehicle, and thus to easily avoid the contact between the detected object and the vehicle.

In the periphery monitoring device according to the aspect of this disclosure, as an example, the control unit may change the display mode of the partial image according to a distance between a position of the object and the position of the vehicle illustrated by the virtual vehicle image. Accordingly, as an example, it is possible to grasp the positional relationship between the vehicle and the object in more detail by checking a change in the display mode of the partial image. Thus, it is possible to more easily drive the vehicle while preventing the vehicle from coming in contact with the detected object.

In the periphery monitoring device according to the aspect of this disclosure, as an example, the control unit may display an index that enables identification of a direction in which the object approaches the vehicle with respect to a traveling direction of the vehicle illustrated by the vehicle image in the composite image when the detection unit is in the operating state, and change a display mode of the index when the detection unit detects the object coming close to the vehicle. Accordingly, as an example, the driver of the vehicle may easily recognize from which direction the object that may come in contact with the vehicle is approaching by visually recognizing the approaching object index whose display mode is changed.

In the periphery monitoring device according to the aspect of this disclosure, as an example, the control unit may display the virtual vehicle image superimposed at a contact position where the vehicle comes in contact with the object, or a position where the vehicle exists when travels to a position before contact with the object, as the position where the vehicle exists when travels by the predetermined distance. As an example, this allows the driver of the vehicle to easily recognize at which position the vehicle may come in contact with the object.

In the periphery monitoring device according to the aspect of this disclosure, as an example, the vehicle image may be a bird's eye view image of the vehicle. Accordingly, as an example, it is possible to exactly grasp the positional relationship between the vehicle and an object in the vicinity thereof.

In the periphery monitoring device according to the aspect of this disclosure, as an example, the virtual vehicle image may be an image illustrating a three-dimensional shape of the vehicle. Accordingly, as an example, a more realistic virtual vehicle image may be displayed on the display unit.

In the periphery monitoring device according to the aspect of this disclosure, as an example, the virtual vehicle image may be a semi-transparent image illustrating the shape of the vehicle. As an example, this allows the driver of the vehicle to easily distinguish the virtual vehicle image from the vehicle image, and to intuitively recognize that the virtual vehicle image is an image illustrating a future position of the vehicle.

In the periphery monitoring device according to the aspect of this disclosure, as an example, the virtual vehicle image may be an image in which a contour of the vehicle is highlighted. As an example, this allows the driver of the vehicle to easily recognize a future position of the vehicle from the virtual vehicle image.

In the periphery monitoring device according to the aspect of this disclosure, as an example, the virtual vehicle image may be an image in which transmittance is increased from a contour of the vehicle toward an inside. As an example, this allows the driver of the vehicle to easily recognize a future position of the vehicle from the virtual vehicle image.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
an acquisition unit configured to acquire a current steering angle of a vehicle;
an image acquisition unit configured to acquire a captured image from an imaging unit that images a periphery of the vehicle; and
a control unit configured to cause a display unit to display a composite image including a vehicle image illustrating the vehicle, and a peripheral image illustrating the periphery of the vehicle based on the captured image, and cause the display unit to display a virtual vehicle image illustrating a shape of the vehicle superimposed at a position where the vehicle exists when travels by a predetermined distance at the current steering angle acquired by the acquisition unit based on a position of the vehicle illustrated by the vehicle image in the composite image when a detection unit capable of detecting an object coming in contact with the vehicle is in an operating state.

2. The periphery monitoring device according to claim 1, wherein
when the object is detected by the detection unit, the control unit changes a display mode of a partial image of a portion coming in contact with the object in the virtual vehicle image, and stops movement of the virtual vehicle image in the composite image at a contact position where the vehicle comes in contact with the object.

3. The periphery monitoring device according to claim 2, wherein
the virtual vehicle image is an image that illustrates the shape of the vehicle and is constituted by polygons, and
the partial image is a polygon of the portion coming in contact with the object, among the polygons constituting the virtual vehicle image.

4. The periphery monitoring device according to claim 2, wherein
the control unit changes the display mode of the partial image according to a distance between a position of the object and the position of the vehicle illustrated by the virtual vehicle image.

5. The periphery monitoring device according to claim 1, wherein
the control unit displays an index that enables identification of a direction in which the object approaches the vehicle with respect to a traveling direction of the vehicle illustrated by the vehicle image in the composite image when the detection unit is in the operating state, and changes a display mode of the index when the detection unit detects the object coming close to the vehicle.

6. The periphery monitoring device according to claim 1, wherein
the control unit displays the virtual vehicle image superimposed at a contact position where the vehicle comes in contact with the object, or a position where the vehicle exists when travels to a position before contact with the object, as the position where the vehicle exists when travels by the predetermined distance.

7. The periphery monitoring device according to claim 1, wherein
the vehicle image is a bird's eye view image of the vehicle.

8. The periphery monitoring device according to claim 1, wherein
the virtual vehicle image is an image illustrating a three-dimensional shape of the vehicle.

9. The periphery monitoring device according to claim 1, wherein
the virtual vehicle image is a semi-transparent image illustrating the shape of the vehicle.

10. The periphery monitoring device according to claim 1, wherein
the virtual vehicle image is an image in which a contour of the vehicle is highlighted.

11. The periphery monitoring device according to claim 1, wherein
the virtual vehicle image is an image in which transmittance is increased from a contour of the vehicle toward an inside.
